(19) United States
(12) Patent Application Publication
(10) Pub. No.: US 2011/0140802 A1
(43) Pub. Date: Jun. 16, 2011

(54) Electrical Coupler and Communication Apparatus Comprising Such an Electrical Coupler

(75) Inventor: Sebastien Pruvost, Froges (FR)

(73) Assignee: STMicroelectronics SA, Montrouge (FR)

(21) Appl. No.: 12/953,217

(22) Filed: Nov. 23, 2010

(30) Foreign Application Priority Data
Dec. 15, 2009 (FR) 09-58988

(51) Int. Cl. H01P 5/12

(52) U.S. Cl. 333/100

(57) ABSTRACT

Device comprising a first input configured to receive a first input signal of given wavelength, several distinct pairs of outputs, the two outputs of each pair of outputs being configured to deliver a differential output signal, and an electrically conducting transmission means forming a closed circuit and coupled between the first input and the outputs, at least one length of the portion of the transmission means, coupled between two outputs of a pair of outputs, being substantially equal to an even multiple of a quarter of the said wavelength, the lengths of those portions of the transmission means which couple two homologous outputs of two pairs of outputs being substantially equal, and at least one length of the portion of the transmission means, coupled between the first input and the output closest to the said first input, being substantially equal to a quarter of the said wavelength.

This application claims the priority benefit of French Patent Application 09-58988, which was filed Dec. 15, 2009, and entitled “Electrical Coupler and Communication Apparatus Comprising Such an Electrical Coupler,” which is hereby incorporated by reference to the maximum extent allowable by law.

### TECHNICAL FIELD

The invention relates especially to electrical couplers, in particular to communication apparatuses comprising such an electrical coupler.

### BACKGROUND

Generally, electrical couplers are components having three accessways or ports, namely one input and two outputs, and in which a signal applied to the input has its power divided by two and restored at the two outputs. Conversely, an electrical coupler can also comprise two inputs and one output, in this case the powers of the two input signals are combined on output from the coupler.

It is for example possible to cite the coupler of hybrid type whose accessways are configured in such a way that the output signals are in quadrature as regards their phase relation, that is to say the two output signals are mutually phase-shifted by 90°.

It is also possible to cite the electrical coupler of the circle-shaped type, commonly designated by the person skilled in the art by the name “rat-race” whose accessways are configured in such a way that the output signals are in opposition as regards their phase relation, that is to say the two output signals are mutually phase-shifted by 180° and form a differential output signal.

But no electrical coupler exists which can generate several differential output signals having the same power.

Furthermore, it is beneficial to provide a single electrical coupler which can generate several pairs of mutually phase-shifted differential output signals.

The use of a single electrical coupler makes it possible to decrease the size of integrated circuits, such as for example those used when processing the signals during transmission and reception in contemporary cellular telephones.

Moreover, the design of a single electrical coupler makes it possible to facilitate the large-scale manufacture of these couplers, and also makes it possible to guarantee prescribed electrical operating standards imposed in terms of signal power.

### SUMMARY OF THE INVENTION

In one aspect, the present invention provides for a device comprising a first input configured to receive a first input signal of given wavelength and a plurality of distinct pairs of outputs. The two outputs of each pair of outputs are configured to deliver a differential output signal. The device further comprises an electrically conducting transmission means forming a closed circuit and coupled between the first input and the outputs. At least one length of a portion of the transmission means, coupled between two outputs of a pair of outputs, is substantially equal to an even multiple of a quarter of said wavelength. The lengths of portions of the transmission means which couple two homologous outputs of two of said plurality of distinct pairs of outputs are substantially equal. At least one length of a portion of the transmission means, coupled between the first input and a first output closest to said first input, is substantially equal to a quarter of said wavelength.

In another aspect, the present invention provides for a device comprising a plurality of distinct pairs of inputs configured to receive respectively a plurality of differential input signals, each of said differential input signals having the same wavelength. The device also includes a first output configured to emit a first output signal and an electrically conducting transmission means forming a closed circuit and coupled between the first output and the plurality of distinct pair of inputs. The transmission means has a first portion coupled between two inputs of a first pair of said plurality of distinct pairs of inputs having a length substantially equal to an even multiple of a quarter of said wavelength. The transmission means further has additional second portions coupled between two homologous inputs of respective pairs of inputs, each having a length substantially equal. The transmission means also has a third portion coupled between the first output and the input closest to the said first output having a length substantially equal to a quarter of the said wavelength.

### BRIEF DESCRIPTION OF THE DRAWINGS

Other advantages and characteristics will be apparent on examining the detailed description of wholly non-limiting embodiments of the invention, and the appended drawings in which:

FIGS. 1 to 4 illustrate in a schematic manner various embodiments of an electrical coupler;

FIGS. 5 and 6 illustrate in a schematic manner two embodiments of an electrical coupler in integrated form;

FIGS. 7 to 9 illustrate in a schematic manner the curves of the output signals of an electrical coupler; and

FIG. 10 illustrates in a schematic manner a wireless communication apparatus.

### DETAILED DESCRIPTION OF ILLUSTRATIVE EMBODIMENTS

Before describing specific embodiments in detail, embodiments are described generally herein. There is disclosed herein an electrical coupler making it possible to provide at least two pairs of output signals, the two output signals of a pair being signals in phase opposition or substantially in phase opposition (to take account of the technological inaccuracies of production), and thus forming a differential output signal, the two differential signals each having substantially the same power, and furthermore being mutually phase-shifted.

According to one aspect, there is proposed a device comprising a first input configured to receive a first input signal of given wavelength, several distinct pairs of outputs, the two outputs of each pair of outputs being configured to deliver a differential output signal, and an electrically conducting transmission means forming a closed circuit and coupled between the first input and the outputs.

In this device, at least one length of the portion of the transmission means, coupled between two outputs of a pair of outputs, is substantially equal to an even multiple of a quarter of the said wavelength, the lengths of the portions of the transmission means which couple two homologous outputs of two pairs of outputs being substantially equal (to take account of the technological inaccuracies of production), and at least one length of the portion of the transmission means, coupled between the first input and the output closest to the said first input, is substantially equal to a quarter of the said wavelength.

Thus for example a single electrical coupler able to deliver at least two mutually phase-shifted differential output signals is provided. By virtue of such a coupler, the use of several electrical couplers known from the prior art is circumvented.

According to one embodiment, the device comprises just two distinct pairs of outputs. In this embodiment, the coupler therefore provides two mutually phase-shifted differential signals.

Advantageously, the device can furthermore comprise a second input configured to receive a second input signal in phase opposition with the first input signal, and coupled to the transmission means in such a way that at least one length of the portion of the transmission means, coupled between the two inputs, is substantially equal to an even multiple of a quarter of the said wavelength.

This pair of inputs makes it possible to provide a differential input signal to the coupler and thus to increase the power of the differential output signals.

According to another embodiment, the lengths of those portions of the transmission means which are coupled between two homologous outputs of two pairs of outputs are substantially equal to a quarter of the said wavelength.

Thus, a coupler is provided which delivers two differential output signals, that is to say mutually in phase opposition or substantially in phase opposition, and in which the differential signals are in quadrature as regards their phase relation.

This coupler which delivers two differential signals in phase quadrature is particularly suitable for use in a signal processing chain integrated into a wireless communication apparatus. In particular, this coupler may be coupled between a phase-locked loop (PLL) and two mixers of such a processing chain so as to perform for example frequency transpositions on the I and Q pathways which are in phase quadrature.

According to another embodiment, the device can comprise at least one resistive load coupled to the transmission means in such a way that the length of the portion of the transmission means, coupled between at least one output and the said load, is substantially equal to a quarter of the said wavelength.

This resistive load makes it possible to absorb nuisance signals corresponding to the reflections of input and output signals which appear within the transmission means. Indeed, the inaccuracy in the lengths of the portions of the transmission means generates reflection signals in the transmission means which disturb the output signals and also the input signals.

Furthermore, this resistive load makes it possible to ensure improved operation of the coupler whatever the impedance variations of the outputs, or the various lengths of the transmission means.

The device can be embodied in integrated form within an integrated circuit.

According to one embodiment, the transmission means comprises metal tracks extending over at least one metallization level of the integrated circuit.

According to another aspect, there is proposed a wireless communication apparatus comprising a device such as defined above.

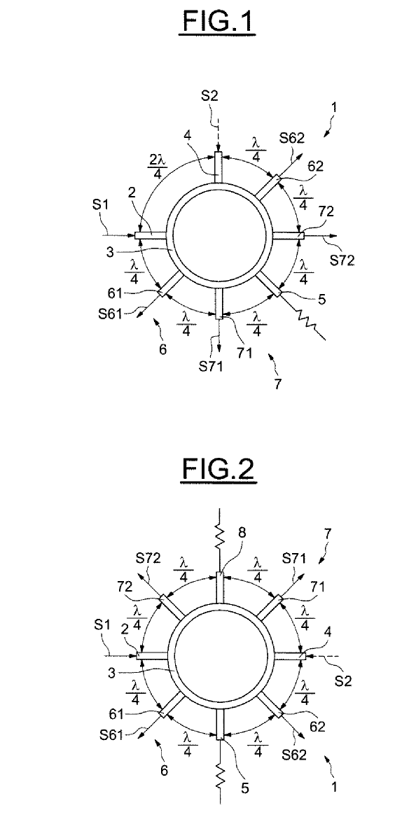

Generally, in FIGS. 1 to 4, the electrical coupler 1 comprises a first input 2 configured to receive a first input signal S1 of given wavelength λ. The coupler 1 furthermore comprises a plurality of pairs of outputs, the outputs of each pair of outputs being configured to deliver respectively two output signals forming a differential signal.

The electrical coupler 1 also comprises an electrically conducting transmission means 3 coupled between the first input 2 and the outputs of each pair of outputs. This transmission means 3, for example a metal line, forms a closed circuit thus making it possible to establish a stationary state for the signals which traverse the whole of the closed circuit 3.

The coupler 1 can further comprise a second input 4 coupled to the transmission means 3 and configured to receive a second input signal S2. The two input signals S1 and S2 are in phase opposition and form a differential input signal. This second input 4 makes it possible, for example, to add a second signal to the transmission means 3 so as to increase the power of the output signals.

In another embodiment, the second input 4 is configured to receive a second input signal having a different wavelength from that of the first input signal S1.

For example, the second input signal has a power different from or equal to that of the first input signal.

The coupler 1 will also be able to comprise at least one resistive load 5 so as to absorb the reflections of the input and output signals in the transmission means 3.

In all the embodiments which will be described subsequently, the length of that portion of the transmission means 3 which is coupled between the first input 2 and the output closest to the said first input 2 (the output 61 in FIG. 1) is substantially equal to a quarter of the given wavelength λ, and the lengths of the portions of the transmission means 3 which couple two homologous outputs 61,71 of two pairs of outputs 6,7 are substantially equal. Thus, a stationary state is established in the transmission means 3 and the coupler can deliver several differential signals.

The general principle of the electrical coupler is that when a signal traverses a length of a portion of the transmission means 3 that is substantially equal to a multiple of a quarter of the wavelength of the input signal, this signal is phase-shifted by an angle α substantially equal to a multiple of 90° with respect to the phase of the input signal.

Moreover, the transmission means 3 forms a closed circuit so that a stationary state is established within the circuit. This stationary state implies that when two outputs of a pair of outputs are coupled by a length of a portion of the transmission means 3 that is substantially equal to an even multiple of a quarter of the wavelength of the input signal, these output signals are mutually phase-shifted by an angle α substantially equal to a multiple of 180°; these signals are then said to be in phase opposition. These two output signals form a differential output signal.

In FIG. 1 a first embodiment has been represented in which the coupler 1 comprises two pairs 6,7 of outputs formed respectively of the two outputs 61,62 and 71,72.

In this embodiment, the lengths of those portions of the transmission means 3 which are coupled between the two outputs 61,62 of the first pair 6 of outputs are substantially equal to the given wavelength λ. The length of that portion of the transmission means 3 which is coupled between the second output 62 of the first pair 6 and the first input S1 is equal to three quarters of the wavelength. Thus, the output signals S61,S62 respectively delivered by the outputs 61,62 of the first pair 6 of outputs are in phase opposition and form a first differential output signal.

Moreover, the length of that portion of the transmission means 3 which is coupled between the two outputs 71,72 of the second pair 7 of outputs is substantially equal to half the given wavelength λ. Thus, the output signals S71,S72 respectively delivered by the outputs 71,72 of the second pair 7 of outputs are also in phase opposition and form a second differential output signal.

Furthermore, the length of that portion of the transmission means 3 which is coupled between the homologous outputs 61,71 of the two pairs 6,7 of outputs is substantially equal to a quarter of the wavelength λ. Thus, the differential output signals delivered by the pairs 6,7 of outputs are in phase quadrature.

Advantageously, the resistive load 5 is coupled to the first input 2, by a length of a portion of the transmission means that is substantially equal to three quarters of the wavelength λ, and is situated between the two outputs 71,72 of the second pair 7 of outputs.

The second input 4 is moreover coupled to the first input 2, by a length of a portion of the transmission means that is substantially equal to half the wavelength λ, and is situated between the first input 2 and the output 62 furthest from the first input 2 belonging to the first pair 6 of outputs.

The coupler may or may not comprise this second input 4 which is optional.

In FIG. 2 a second embodiment of an electrical coupler 1 has been schematically represented, in which certain reference signs described in FIG. 1 also appear.

In this second embodiment, the coupler 1 makes it possible to deliver two differential output signals which are mutually in phase. These two differential output signals are delivered respectively by the two pairs 6,7 of outputs.

Indeed, in this second embodiment, the length of that portion of the transmission means 3 which is coupled between the two outputs 61,62 of the first pair 6 of outputs is substantially equal to half the given wavelength λ.

Moreover, the length of that portion of the transmission means 3 which is coupled between the two outputs 71,72 of the second pair 7 of outputs is substantially equal to half the given wavelength λ.

Furthermore, the length of that portion of the transmission means 3 which is coupled between the homologous outputs 61,71 of the two pairs 6,7 of outputs is substantially equal to the given wavelength λ.

Advantageously, the resistive load 5 is coupled to the first input 2, by a length of a portion of the transmission means 3 that is substantially equal to half the wavelength λ, and is situated between the two outputs 61,62 of the first pair 6 of outputs. A second resistive load 8 is furthermore coupled to the first input 2, by a length of portion of the transmission means 3 that is substantially equal to half the wavelength λ, and is situated between the two outputs 71,72 of the second pair 7 of outputs.

The second input 4 is, for its part, coupled to the first input 2, by a length of a portion of the transmission means that is substantially equal to the wavelength λ.

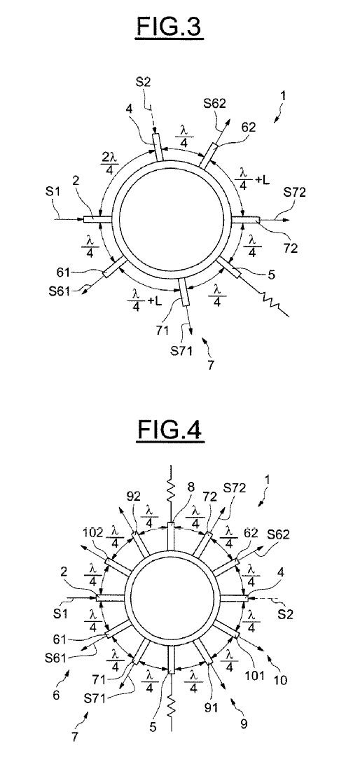

In FIG. 3 a third embodiment of an electrical coupler 1 has been schematically represented, in which certain reference signs described in FIG. 1 also appear.

This third embodiment is a variant of the first embodiment. In this third embodiment, the coupler 1 makes it possible to provide two differential output signals, which are delivered respectively by the two pairs 6, 7 of outputs, and which are mutually phase-shifted by an angle θ which lies between 0° and 360°.

In this third embodiment, the lengths of the portions of the transmission means 3 which couple the respective outputs of each pair of outputs are constant and are substantially equal to an even multiple of a quarter of the wavelength λ. Thus, the output signals within a pair of outputs are always in phase opposition.

Moreover, it will be possible to vary the length of the portion of the transmission means which couples two homologous outputs of each pair of outputs so as to mutually phase-shift the differential output signals by an angle θ which lies between 0° and 360°.

This variation of length is performed in such a way that the length of the portion of the transmission means 3 which couples the first two homologous outputs 61,71 of the two pairs 6,7 is equal to the length of the portion of the transmission means 3 which couples the second two homologous outputs 62,72 of the two pairs 6,7.

Thus, the lengths of the portions of the transmission means 3 which couple respectively the first and second homologous outputs 61,71 and 62,72 can vary. These lengths of portion of the transmission means which are equal to λ/4+L, with L being a real number, have been represented in FIG. 3.

In FIG. 4 a fourth embodiment of a coupler 1 has been represented, which comprises four pairs 6,7,9,10 of outputs. Certain elements previously described in the previous figures also appear in this figure.

In this fourth embodiment, the third and fourth pairs 9,10 of outputs comprise respectively two outputs 91,92 and 101,102.

In this coupler 1, the outputs of each pair of outputs are coupled together by a length of a portion of the transmission means 3 that is substantially equal to 3λ/2. Furthermore, the homologous outputs of the first two pairs 6,7 of outputs are coupled together by a length of a portion of the transmission means 3 being substantially equal to a quarter of the wavelength λ. In the same manner, the homologous outputs of the second two pairs of outputs 9,10 are coupled together by a length of portion of the transmission means 3 being substantially equal to a quarter of the wavelength λ.

Thus, differential output signals which are in phase quadrature with one another are obtained.

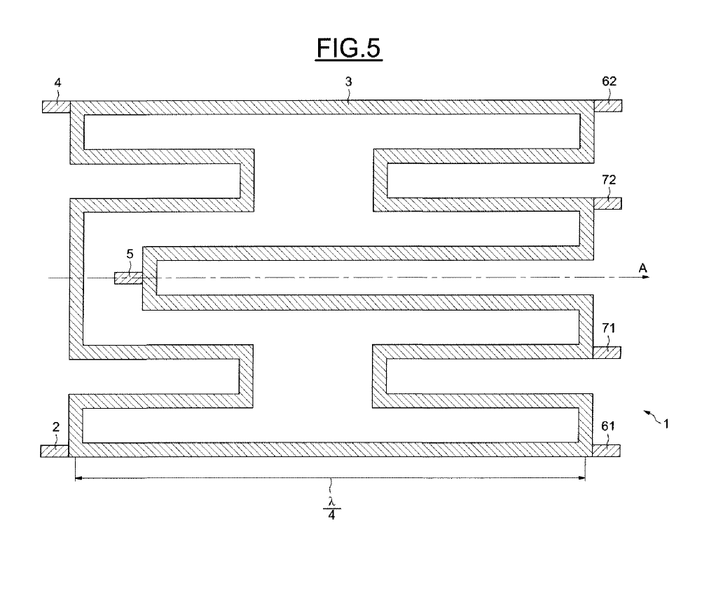

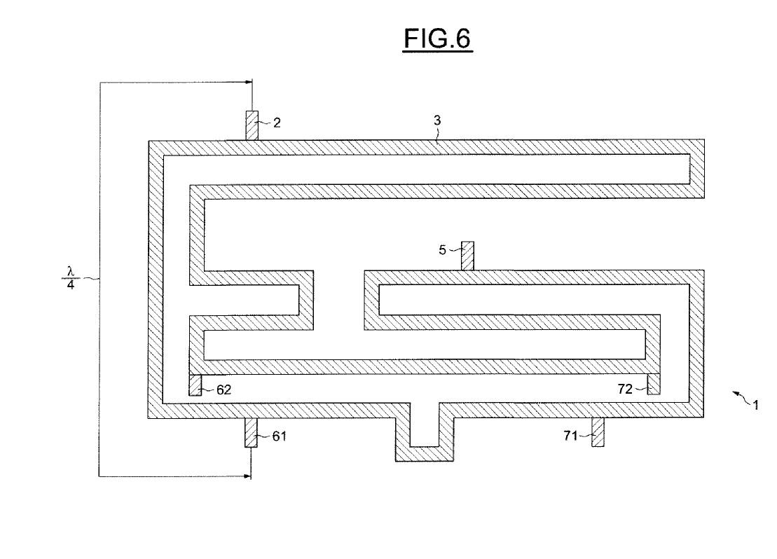

In FIGS. 5 and 6 two embodiments of an electrical coupler 1 such as defined in FIG. 1 have been represented in a schematic manner, in which certain references of the previous FIGS. 1 to 4 also appear.

In these two embodiments, the coupler 1 is embodied in integrated form and it comprises a transmission means 3 having a serpentine form extending over at least one metallization level of the integrated circuit. In the figures, the coupler has been represented extending over a single metallization level; however, the latter will be able to comprise a transmission means extending over several metallization levels by way of contacts commonly called vias or “vias holes” according to the name well known to the person skilled in the art.

In FIG. 5, the coupler 1 possesses an axis of symmetry A passing through the resistive load 5. In FIG. 6, the coupler 1 does not possess any axis of symmetry.

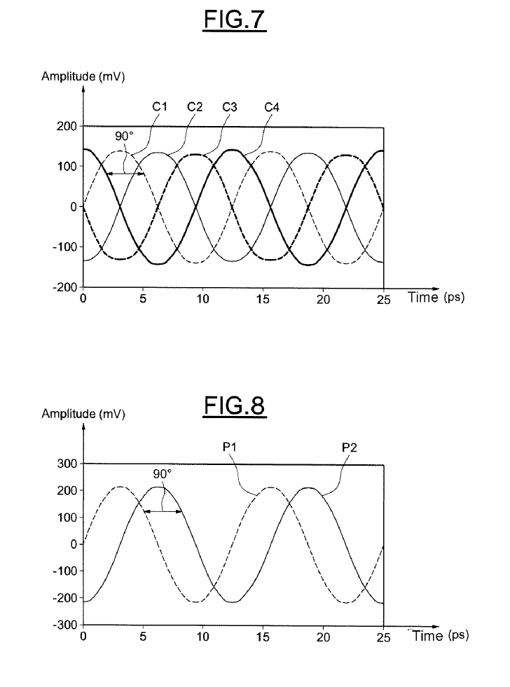

In FIGS. 7 and 8 the output signals of an electrical coupler 1, such as defined in FIG. 1, have been represented in a schematic manner.

Curves C1 to C4 represent respectively the signals S61, S71, S62 and S72, delivered by the outputs 61,71 and 62,72 of the coupler 1. Represented in FIGS. 7 and 8 are the amplitudes (in millivolts) as a function of time (in picoseconds). It will also be noted that the amplitudes of curves C1 to C4, and consequently the powers of the corresponding signals, are not identical.

In FIG. 8 the corresponding two differential output signals P1,P2 have been represented. The differential output signal P1 is delivered by the first pair 6 of outputs and results from the difference between the output signals S61,S62. The differential output signal P2 is delivered by the second pair 7 of outputs and results from the difference between the output signals S71,S72.

The differential output signals P1,P2 have substantially the same power and are mutually phase-shifted by an angle θ substantially equal to 90°.

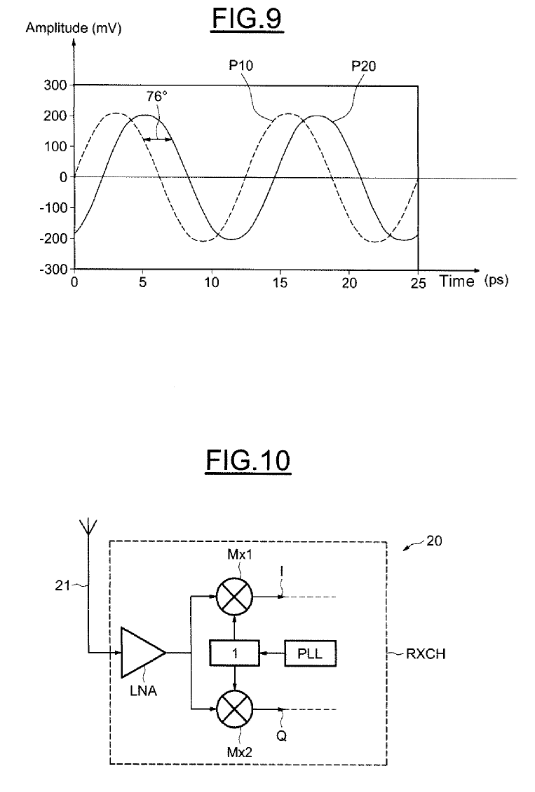

Represented in FIG. 9, by way of example, are the differential output signals P10,P20 of the electrical coupler such as described in FIG. 3. Represented in FIG. 9 are the amplitudes (in millivolts) as a function of time (in picoseconds). The differential output signal P10 delivered by the first pair 6 of outputs results from the difference between the output signals S61,S62. The differential output signal P20 delivered by the second pair 7 of outputs results from the difference between the output signals S71,S72.

The differential output signals P10,P20 do not have substantially the same power and are mutually phase-shifted by an angle θ, for example substantially equal to 76°, corresponding to the phase shift induced by the lengths of those portions of the transmission means 3 which couple respectively the first and second homologous outputs 61,71 and 62,72, which are mutually equal and for example less than λ/4. In FIG. 10 a wireless communication apparatus 20 has been represented in a schematic manner.

This wireless communication apparatus 20 comprises an antenna 21 for transmitting and receiving communication signals with a remote base station. This apparatus conventionally comprises a reception chain RXCH and a transmission chain, not represented here for the sake of simplification.

The reception chain RXCH comprises an analogue part comprising in particular a low noise amplifier LNA connected to two mixers MX1 and MX2 intended to perform a frequency transposition, for example into baseband, with a local oscillator signal delivered by a phase-locked loop PLL.

A coupler 1 of the type of that described above delivers the oscillator differential signal and the oscillator differential signal phase-shifted by 90° to the two mixers MX1 and MX2. Signals on the I pathway and signals on the Q pathway which are mutually in phase quadrature are therefore obtained, after transposition.

The coupler which has just been described can also be used in “reverse”, that is to say the previously described inputs correspond to outputs and the previously described outputs correspond to inputs.

For conciseness and simplification purposes, the figures described above also serve as the basis for the detailed description of a “reverse” coupler, the inputs being outputs and vice versa. For example the reference 51 now designates an output signal, and the reference 6 designates an input pair configured to receive a differential input signal; the sense of the arrows is reversed in this case. Thus, according to another aspect, there is proposed a device comprising several distinct pairs of inputs configured to receive respectively several differential input signals having one and the same wavelength, a first output 2 configured to emit a first output signal S1, an electrically conducting transmission means 3 forming a closed circuit and coupled between the first output 2 and the inputs.

In this device, at least one length of that portion of the transmission means 3 which is coupled between two inputs of a pair of inputs is substantially equal to an even multiple of a quarter of the said wavelength, the lengths of those portions of the transmission means 3 which couple two homologous inputs 61,71 of two pairs of inputs 6,7 are substantially equal, and at least one length of that portion of the transmission means 3 which is coupled between the first output 2 and the input closest to the said first output is substantially equal to a quarter of the said wavelength.

This coupler therefore makes it possible to combine the powers of several input signals so as to deliver a resulting output signal having increased power with respect to that of an input signal.

According to one embodiment, the number of distinct pairs 6,7 of inputs 61,62,71,72 is equal to two.

Advantageously, the device can comprise a second output 4, configured to emit a second output signal S2 in phase opposition with the first output signal S1, and coupled to the transmission means 3 in such a way that at least one length of that portion of the transmission means 3 which is coupled between the two outputs 2,4 is substantially equal to an even multiple of a quarter of the said wavelength.

According to another embodiment, the lengths of those portions of the transmission means 3 which are coupled between two homologous inputs 61,71 of two pairs of inputs 6,7 are substantially equal to a quarter of the said wavelength.

According to another embodiment, the device can comprise at least one resistive load 5 coupled to the transmission means 3 in such a way that the length of that portion of the transmission means 3 which is coupled between at least one input and the said load 5 is substantially equal to a quarter of the said wavelength.

What is claimed is:

1. A device comprising:
a first input configured to receive a first input signal of given wavelength;
a plurality of distinct pairs of outputs, the two outputs of each pair of outputs being configured to deliver a differential output signal; and
an electrically conducting transmission means forming a closed circuit and coupled between the first input and the outputs, wherein
at least one length of a portion of the transmission means, coupled between two outputs of a pair of outputs, is substantially equal to an even multiple of a quarter of said wavelength,
the lengths of portions of the transmission means which couple two homologous outputs of two of said plurality of distinct pairs of outputs are substantially equal, and
at least one length of a portion of the transmission means, coupled between the first input and a first output closest to said first input, is substantially equal to a quarter of said wavelength.

2. The device according to claim 1, in which the number of distinct pairs of outputs is equal to two.

3. The device according to claim 1, further comprising:
a second input, configured to receive a second input signal in phase opposition with the first input signal, and coupled to the transmission means in such a way that at least one length of a portion of the transmission means, coupled between the first and second inputs, is substantially equal to an even multiple of a quarter of said wavelength.

4. The device according to claim 1, wherein the lengths of portions of the transmission means which are coupled between two homologous outputs of two of said plurality of distinct pairs of outputs are substantially equal to a quarter of the said wavelength.

5. The device according to claim 1, further comprising:
at least one resistive load coupled to the transmission means in such a way that the length of a portion of the transmission means, coupled between at least one output and said load, is substantially equal to a quarter of the said wavelength.

6. A device comprising:
a plurality of distinct pairs of inputs configured to receive respectively a plurality of differential input signals, each of said differential input signals having the same wavelength;
a first output configured to emit a first output signal and
an electrically conducting transmission means forming a closed circuit and coupled between the first output and the plurality of distinct pair of inputs, and having:
a first portion coupled between two inputs of a first pair of said plurality of distinct pairs of inputs having a length substantially equal to an even multiple of a quarter of said wavelength,
additional second portions coupled between two homologous inputs of respective pairs of inputs, each having a length substantially equal, and
a third portion coupled between the first output and the input closest to the said first output having a length substantially equal to a quarter of the said wavelength.

7. The device according to claim 6, in which the number of distinct pairs of inputs is equal to two.

8. The device according to claim 6, further comprising:
a second output, configured to emit a second output signal in phase opposition with the first output signal, and coupled to the transmission means in such a way that at least one length of a portion of the transmission means, coupled between the two outputs, is substantially equal to an even multiple of a quarter of said wavelength.

9. The device according to claim 6, wherein respective lengths of respective portions of the transmission means which are coupled between two homologous inputs of two of said plurality of distinct pairs of inputs are substantially equal to a quarter of the said wavelength.

10. The device according to claim 6, further comprising:
at least one resistive load coupled to the transmission means in such a way that a length of a portion of the transmission means, coupled between at least one input and said resistive load, is substantially equal to a quarter of the said wavelength.

11. The device according to claim 1 embodied in integrated form within an integrated circuit.

12. The device according to claim 11, in which the transmission means comprises metal tracks extending over at least one metallization level of the integrated circuit.

13. The device according to claim 1 further comprising a wireless communication apparatus.

14. The device according to claim 13, in which the device is connected between a local oscillator and a frequency transposition stage.

15. The device according to claim 6 embodied in integrated form within an integrated circuit.

16. The device according to claim 15, in which the transmission means comprises metal tracks extending over at least one metallization level of the integrated circuit.

17. The device according to claim 6 further comprising a wireless communication apparatus.
